(19) United States
(12) Patent Application Publication
(10) Pub. No.: US 2007/0162849 A1
(43) Pub. Date: Jul. 12, 2007

(54) Interactive kitchen recipe workstation

(76) Inventor: Elizabeth Marciano, New York, NY (US)

Correspondence Address: Elizabeth Marciano, 101 West 74th Street Apt. 3E, New York, NY, 10023, US

(21) Appl. No.: 11/327,691

(22) Filed: Jan. 9, 2006

(51) Int. Cl. G06F 3/00

(52) U.S. Cl. 715/700

(57) ABSTRACT

A specialized workstation for accessing, entering, and amending recipes and shopping lists. A user can create new, or access stored, recipes and grocery lists via the touch-sensitive screen by tapping or scrawling on the screen with a stylus or finger, or by utilizing a keyboard which can be displayed on the screen.

Recipes are handed from mother to daughter and between friends. They are tested, filed away, and pulled out repeatedly for use over the years and generations. Even in a short span of time, a cook can end up with an overflowing recipe box, book, or folder. Such recipe receptacles are filled with recipes in various handwriting on different sized cards, torn from the backs of food containers and magazines, and Photostat copies from various other media. Keeping track of all the recipes, as well as keeping the recipes themselves legible and useable, is problematic due to the reality of recipe usage. Active kitchens, with open and/or spilled food, wet and/or dirty hands, and often limited space prove hostile to the preservation of recipes. Over time, much used and loved recipes must be rewritten to remain legible. Additionally, maintaining a large and ever-growing recipe collection in a semblance of order so as to be able to recover specific recipes, is an ongoing job. Maintaining a recipe collection in paper media requires time and effort that few home cooks can spare.

With a specialized workstation for accessing, entering, and amending recipes and shopping lists, the whole process of maintaining and using recipes is streamlined. A user can create new, or access stored, recipes and grocery lists via the touch-sensitive screen by tapping or scrawling on the screen with a stylus or finger, or by utilizing a keyboard which can be displayed on the screen.

Recipes or grocery lists can be added manually by typing it into the interface via the touch-sensitive screen, can be downloaded from the internet or recipe management software via the USB port, or can be scanned and then loaded into the workstation via the USB port. The workstation can operate commercially-available recipe software. This ensures that recipes only have to be added to the collection once. Recipes can then be saved and stored electronically, allowing for easy reorganization and recall. Additionally, the workstation can operate commercially available work processing, list-making, or day-planning software, enabling the user to write shopping lists, check schedules, and perform other tasks while cooking, planning meals, and/or inputting recipes. Using the modem or USB port, the user can access online food-ordering websites and place orders for groceries. A timer built into the decorative surround cuts down on the number of individual gadgets cluttering up the kitchen and allows the recipe being followed on the interface to be clocked via the built-in timer.

### BRIEF DESCRIPTION OF THE DRAWINGS

In the drawings:

FIG. 1 is a frontal view of the present specialized computer workstation;

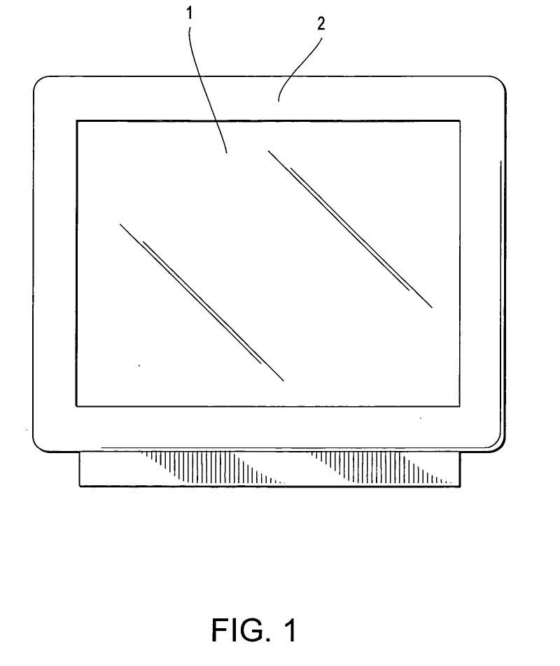

FIG. 2 is a back view of the present specialized computer workstation;

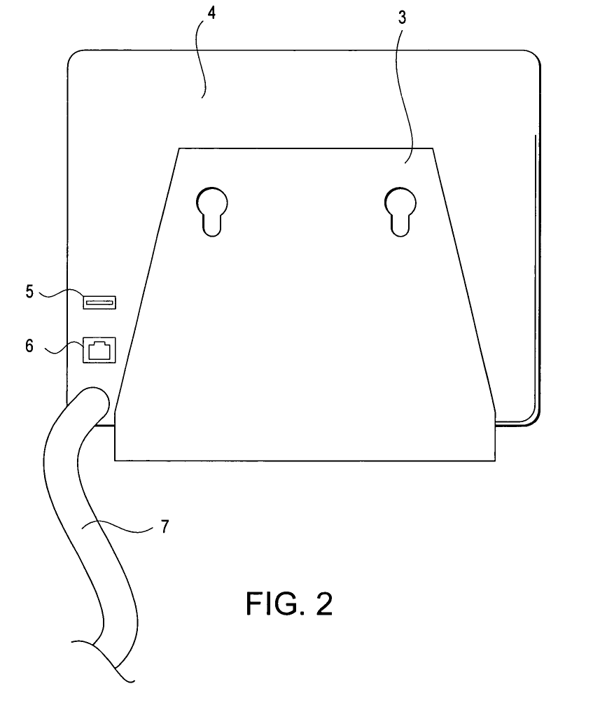

FIG. 3 is a side view of the present specialized computer workstation.

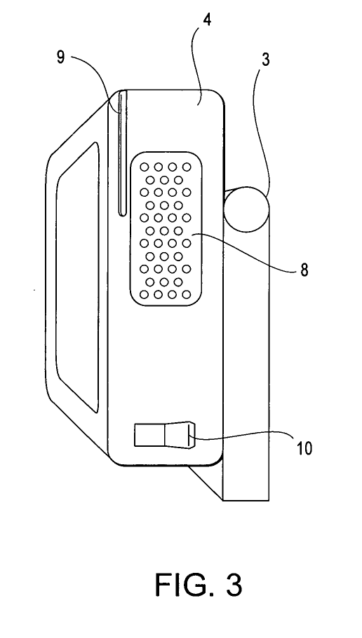

### DETAILED DESCRIPTION OF THE PREFERRED EMBODIMENT

An on-screen keyboard can be called up by tapping on a small keyboard button on the workstation surround (2). A user can then type on the touch-sensitive screen (1) as on a regular keyboard. The workstation can be hung on a wall via the built-in hanging member, or can be propped up on a counter or tabletop via the fold-out back (3). This keeps the workstation both accessible during the process, while keeping it out of the mess and allows the cook to easily follow the recipe, without worrying about the recipe being blown off the counter or losing the page in a recipe book.

The workstation screen has a decorative surround (2). In the preferred embodiment, a stylus can be stored in a holder (9) in the surround. In the preferred embodiment, the surround contains speakers (8), enabling the workstation to play audio. An on/off button (10) is located in the surround. The workstation has a power cord (7), allowing it to be plugged into a standard outlet as a power source. Alternatively, the workstation can run off an internal battery. In the preferred embodiment, a USB port (5) and modem outlet (6) are also situated in the back of the workstation. The entire workstation, including the surround, is water-resistant, allowing worry-free use in a busy kitchen.

The specialized workstation simplifies shopping, cooking, and recipe maintenance by providing users with a large, easy to clean, computerized workstation that organizes and accesses recipes, allows for the planning of future meals and the preparation of shopping lists, and allows access to online food-ordering websites.

What is claimed is:

1. A specialized computer workstation comprising
a workstation capable of running commercially-available software;
a touch sensitive interface mounted in a decorative surround;
a power cord and plug; and
a system for maintaining the workstation at or about vertical.

2. The specialized workstation of claim 1 where the system for maintaining the workstation at or about vertical is an easel-type back which can be folded out from the back of the workstation.

3. The specialized workstation of claim 1 where the system for maintaining the workstation at or about vertical is one or more indentations in the back of the workstation which can receive wall-mounted hangers.

4. The specialized workstation of claim 1 where speakers are located in the decorative surround.

5. The specialized workstation of claim 1 where a stylus is located in the decorative surround.

6. The specialized workstation of claim 1 additionally comprising a USB port.

7. The specialized workstation of claim 1 additionally consisting of a modem plug.

8. The specialized workstation of claim 1 additionally consisting of a programmable timer built into the decorative surround.
